(19) United States
(12) Patent Application Publication
(10) Pub. No.: US 2013/0305130 A1
(43) Pub. Date: Nov. 14, 2013

(54) Systems and Method for Building and Publishing Complex Documents with Component Revenue Tracking

(71) Applicants: David Neil Slatter, Bristol (GB); Darryl Greig, Fishponds (GB); Andrew Hunter, Bristol (GB)

(72) Inventors: David Neil Slatter, Bristol (GB); Darryl Greig, Fishponds (GB); Andrew Hunter, Bristol (GB)

(21) Appl. No.: 13/823,219

(22) PCT Filed: Jan. 25, 2011
(86) PCT No.: PCT/US11/22440

§ 371 Date: Mar. 14, 2013

(51) Int. Cl. G06F 17/21

(52) U.S. Cl. CPC G06F 17/212
USPC 715/202

(57) ABSTRACT

Systems and methods (150) are provided for budding and publishing a complex document. An example method (150) can include providing, to a user device, a graphical user interface (GUI) to a document builder and publisher to display a target complex document and a source complex document (152) and copying components from the source complex document to the target complex document in response to user input to build a new complex document (154). The method (150) can further include receiving a document order for the new complex document (156) and analyzing the document order to generate a list of components revenues and associated authors assigned to respective component revenues (158).

### BACKGROUND

Tools exist for building documents. One such tool for the creation of photo books, greeting cards, calendars and posters features a template approach where each template supports a small number of layout variants. Various decorative themes are available through menus and sidebars. The tool utilizes a single document model and provides interface modes that allow a user to choose from predefined content and content attributes. Other tools employ complex interfaces that may require detailed knowledge of the tool to build documents. If a complex document built in this manner uses content (images, fonts, graphics, layouts and blocks of text) that is commercially licensed from a third party, then license agreements together with the payment of license fees are made as part of the document building process. Such agreements may require considerable time and knowledge on the part of both the content provider and the document creator to fit the specific needs of the document creator. The complexity increases further if the document is to be published for financial gain or published in such a way that the individual components may be re-used.

### BRIEF DESCRIPTION OF THE DRAWINGS

FIG. 1 illustrates a block diagram of an example of a system for building and publishing complex document with component revenue tracking.

FIG. 2 illustrates a block diagram of an example of a complex document.

FIG. 3 illustrates an example of a multi-level hierarchical data structure corresponding to a spread.

FIG. 4 illustrates an example of a revenue generation list associated with the multi-level hierarchical data structure of FIG. 3.

FIG. 5 illustrates a block diagram of an example document builder graphical user interface (GUI) for building and publishing complex documents.

FIG. 6 illustrates a flow chart of an example method for building and publishing complex documents.

### DETAILED DESCRIPTION

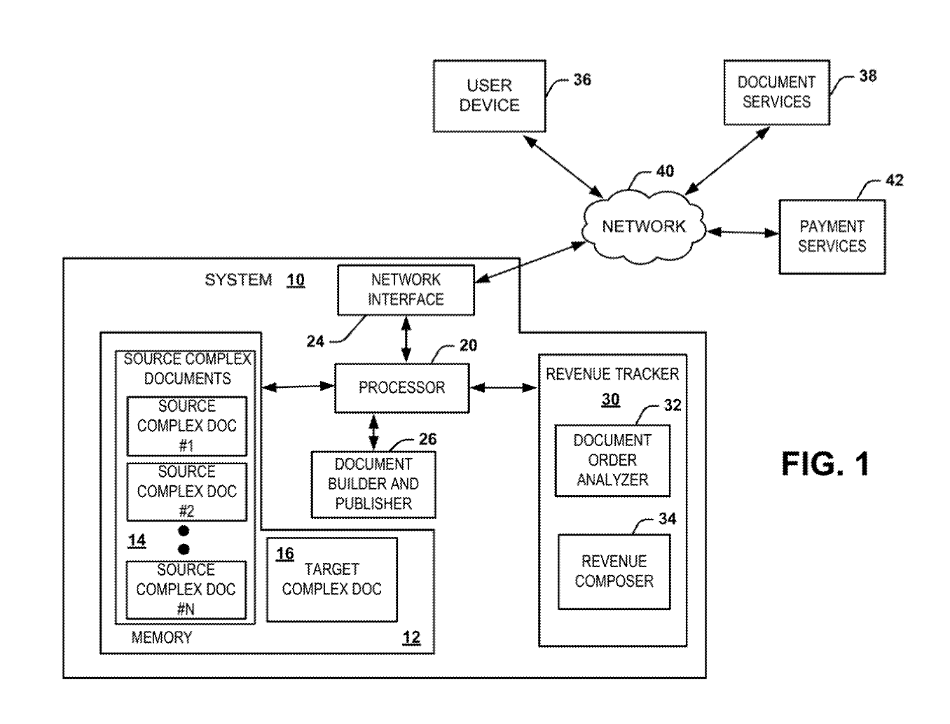

FIG. 1 illustrates a block diagram of an example of a system 10 for building and publishing complex documents with component revenue tracking. The system 10 can reside at a remote service on a server accessible via a network interface 24 by user devices 36 over a network 40, such as the Internet. The system 10 includes a document builder and publisher 26 having computer executable instruction executable by a processor 20. The document builder and publisher 26 allows a user to build a target complex document 16 employing content of one or more source complex documents 14 with both the source complex documents 14 and the target complex document 16 residing in memory 12. The document builder and publisher 26 can be provided to a user device 36 as a user interface that can be implemented as a network browser that is capable of specifying a resource locator for a webpage (ag., a uniform resource locator (URL)). or a file location (e.g., a resource location that is served via a file transfer protocol (FTP)), which are accessible via the network 40 by the network interface 24. Thus, the processor 20, in response to user input instructions received via the user interface, can access and retrieve content from the memory 12 of the system 10.

As used herein, the term “includes” means includes but not limited to, the term “including” means including but not limited to. The term “based on” means based at least in part on. As used herein, a complex document refers to a document that contains a group of elements selected from the group comprising text elements with associated fonts, graphical elements and image elements residing in containers with associated layout formats. An image element is a pixel array, such as, for example, a photo. A graphical element can be a pixel array but may often have a vector representation (e.g. including scalable vector graphics (SVG)) associated with the graphical element. The vector representations are readily scalable without the loss of quality. Graphical elements can be used for borders and decoration, logos, diagrams, etc. A text element can be a block of text, or a text header. Text of a header can include an emphasis such as large text, bolding, underlining, etc, and a tag to identify that it is to be put at a top of a layout or first in a layout. The layout of these elements is fully two dimensional, such that it is not restricted to folding a one dimensional thread of characters and images into a fixed column or page. A complex document can also comprise layout formats and layouts of layouts.

Content includes elements, fonts of elements, groups of elements, pages, spreads and layout formats that may be associated with a group of elements, a page, a spread or layouts of layouts. Attributes are assigned to each component of content such that a cost and revenue can be assigned to that component. That is, a cost to a user and a revenue to an author. For example, an attribute can be element authorship, element type, price of using the element, element font, font author, font price, element resolution constraints, various image resolution prices, etc. A component can be an element, an element in a group of elements, the font used to render one or more text elements, an element in a page or spread, or a layout format of a group of elements, a page or spread. A layout format can include a fixed layout or a dynamic layout with an associated layout engine and layout parameters that determine a layout based on statistics or some other technique.

The system uses an initial set of source complex documents 14 to facilitate the creation of a new target complex document 16 through re-use. This initial set may be drawn from a number of sources, including complex documents pre-populated by the system owner (potentially offering free images, fonts, layouts, etc to encourage the creation of new documents), complex documents populated by third party licensed content owners who have entered into agreements with the system owner, or complex documents populated with content contributed by users under suitable agreements to enable publishing for re-use.

There is no charge to the user for copying of the content from the source complex documents 14 to the target complex document 16. Upon completion of the target complex document 16 by a user, the user can publish the target complex document 16 at which point the target complex document is added to the set of source complex documents 14 and made available for purchase or re-use by other users of the system 10. A user may chose to publish the target complex document privately in which case the published complex document is available to a select group of users. The user can also print the target complex document 16 locally via a document order, or request delivery of copies of the target complex document 16 to be delivered to the user by a document order via document services 38. Other users are able to view a published complex document from within the document builder and publisher 26, and therefore access and view that document, and re-use components within that document during creation of their own complex documents. Furthermore, the processor 20, in response to user input instructions received via the document builder and publisher 26, can order copies of any of the published complex documents. Upon completion of a purchase of a published complex document, a document order is sent to document services 38 to be sent to the purchaser. In one instantiation the processor 20, in response to user instructions, may present a restricted version of the document builder and publisher 26 in which only browsing and purchasing functionality is enabled.

A revenue tracker 30, having computer executable instructions executable by the processor 20, includes a document order analyzer 32 and a revenue composer 34. The document order analyzer 32 analyzes document orders and generates a list of component revenues and associated authors assigned those revenues by analyzing the complex document components and assigned cost and revenue of each component. The document order analyzer 32 can also provide a user an aggregated cost and revenue associated with copied source content to the user prior to a user publishing or printing a target complex document so that the user is informed of costs associated with utilizing and selling the copied source content. The document order analyzer 32 provides a complex document revenue list and a number of complex document orders to a revenue composer 34. The revenue composer aggregates the revenues for each respective author and document copy and periodically (e.g., monthly) generates a revenue order to be sent to payment services 42 for providing payments to each of the respective authors. The payment services 42 can also receive and process payments for purchased complex documents by users of the system 10.

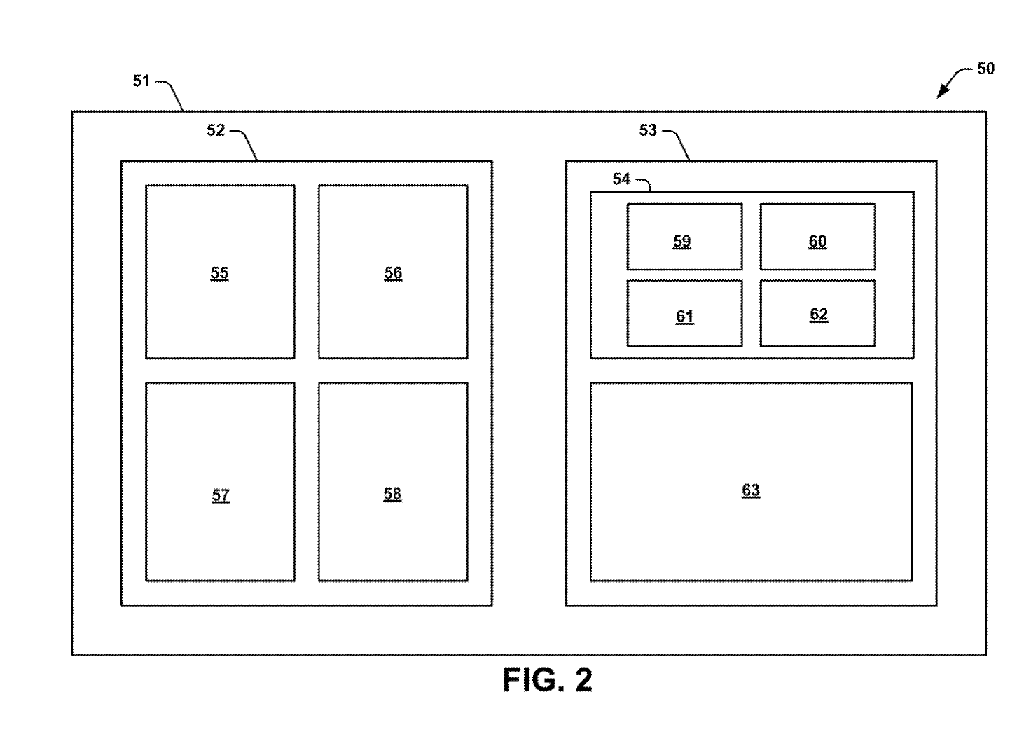

FIG. 2 illustrates an example block diagram of a complex document 50. The complex document 50 includes image elements 55-63 and text elements 61-63. Text elements can have particular fonts associated therewith. Image elements 59 and 60 and text elements 61 and 62 reside within a grid type layout 54. Image elements 55-58 reside in a first page layout 52. The grid layout 54 and text element 63 reside in a second page layout 53. Pages 52 and 53 reside in a spread layout 51 containing the two pages 52 and 53. Examples of a complex document can be a magazine, a book, a newspaper, a periodical or other publishable type of document. The modifier “source” is intended to indicate that the document is to be used as a source of content. As such, the source complex document can be write-protected upon its creation, such that any part or the entire document can be copied into a target complex document without causing or allowing changes to the source complex document. The copied content can be manipulated and edited within the target complex document.

A complex document is represented for computation by a structure of elements and containers. A container is defined as a group of document elements and a layout format comprising a specific layout engine and layout parameters to be used to arrange these elements. The layout engine arranges and modifies the elements in its container to fill the shape and size of the available surface (e.g., page). Containers can include containers to support complex documents which comprise layouts of layouts. The resulting structure can be described as multi-level hierarchical. Examples of containers include pages, spreads including two facing pages, a group of images, a group of images with titles and others. The results of the container layout operation are displayed in the browser window. Individual text, graphic or image elements can be selectable by pointing to the elements. A container is selectable by pointing at a margin drawn around its elements or a gap between its elements or by a region revealed when the pointer is in the neighborhood of the container's elements. Document creation and editing is accomplished by dragging a selected element or a container on to other element containers. Dragging an element on to another element indicates a replace operation. Dragging an element on to a container indicates an operation to add the element to the container. After the container structures have been edited to reflect the user inputs, the container layout engines run and the new arrangement is displayed in the browser window.

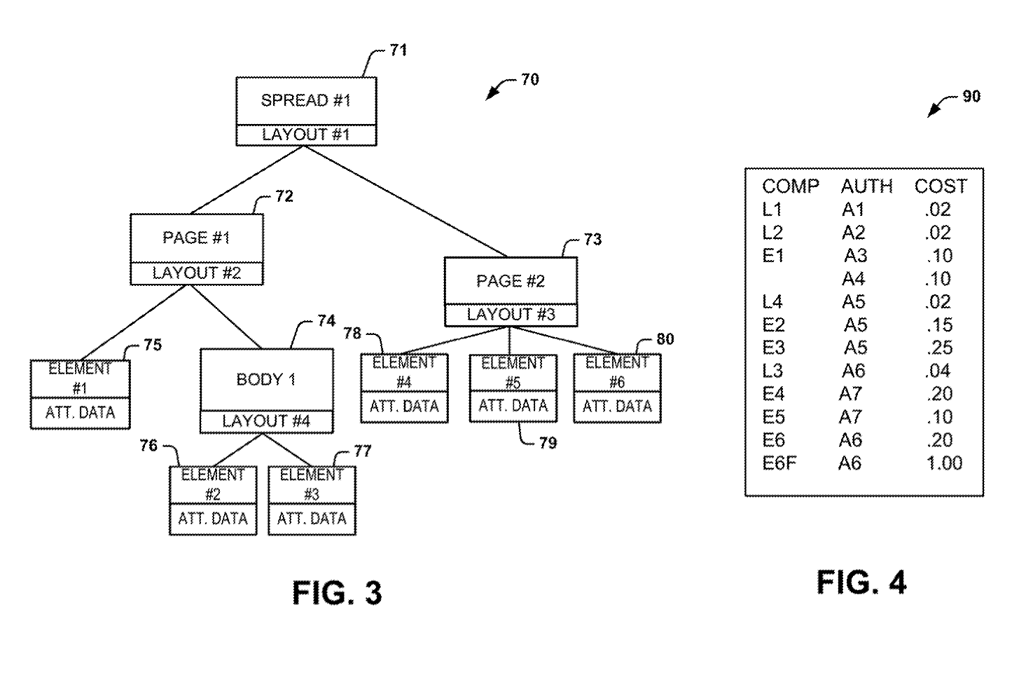

FIG. 3 illustrates an example of a multi-level hierarchical data structure 70 corresponding to a spread. The data structure 70 can be represented as a binary tree having a plurality of container nodes 71-74 and a plurality of content nodes 75-80. In the example of FIG. 3, the content nodes 75-80 are implemented as leaf nodes corresponding to the container nodes 71-74. Each of the content elements includes associated attribute data, such as element type, element authorship and component revenue or cost. Text elements also include attribute data associated with the various fonts utilized. A given complex document can be formed of multiple spreads, which may be the same or different depending on the layout format of the container.

In the example of FIG. 3, the spread 71 includes a Layout Format #1, a first page container node 72 (“Page 1”) that includes a Layout Format #2 and a second page container node 73 (“Page 2”) that includes a Layout Format #3. The first and second page container nodes 72 and 73 are associated with the first and second pages, respectively, of the spread. Branching from the container node 72 are a leaf node 75 (Element #1) and another container node 74 (“Body 1”). The container node 74 includes a Layout Format #4 and further includes two child content nodes 76 and 77, demonstrated as Element #2 and Element #3. The container node 73 includes three child leaf content nodes 78-80, demonstrated as Element #4, Element #5 and Element #6. Each layout format can be fixed or dynamic. A dynamic format includes a layout engine and associated layout parameters that layouts elements within a container employing a statistical model or some other model. The example of FIG. 3 demonstrates but one example of a hierarchical representation for a spread that can be implemented in source complex document or a target complex document. Various other structures and content can be utilized based on the teachings herein.

FIG. 4 illustrates an example of a revenue generation list 90 associated with the multi-level hierarchical data structure 70 of FIG. 3. The revenue generation list 90 comprises components (elements, fonts and layout formats), authors of the components and a revenue associated with each component upon consumption (i.e. purchase) of the complex document containing the spread. Layout #1 generates a revenue of 2 cents to author A1 and layout #2 generates a revenue of 2 cents to author A2 for each sale of a complex document that includes the spread. Element #1 includes two authors A3 and A4. Therefore, a revenue of 20 cents is apportioned between the two authors A3 and A4, such that each author receives a revenue of 10 cents for each sale of a complex document that includes the spread. Layout #4, Element #2 and Element #3 are all authored by author A5. A revenue of 2 cents for layout #4, a revenue of 15 cents for Element #2, and a revenue of 25 cents for Element #3 is generated to author A5 for each sale of a complex document that includes the spread. A revenue of 4 cents for Layout #3, a revenue of 20 cents for Element #4, and a revenue of 10 cents for Element #5 is generated to author A6. A revenue of 20 cents is generated for Element #6 to author A7 for each sale of a complex document that includes the spread. Additionally, a revenue of 1 dollar is generated to author A6 for each sale of the complex document that includes the spread for utilizing a font (E6F) of Element #6 anywhere in the complex document. Alternatively, a revenue amount can be based on the volume use of the particular font utilized in the complex document.

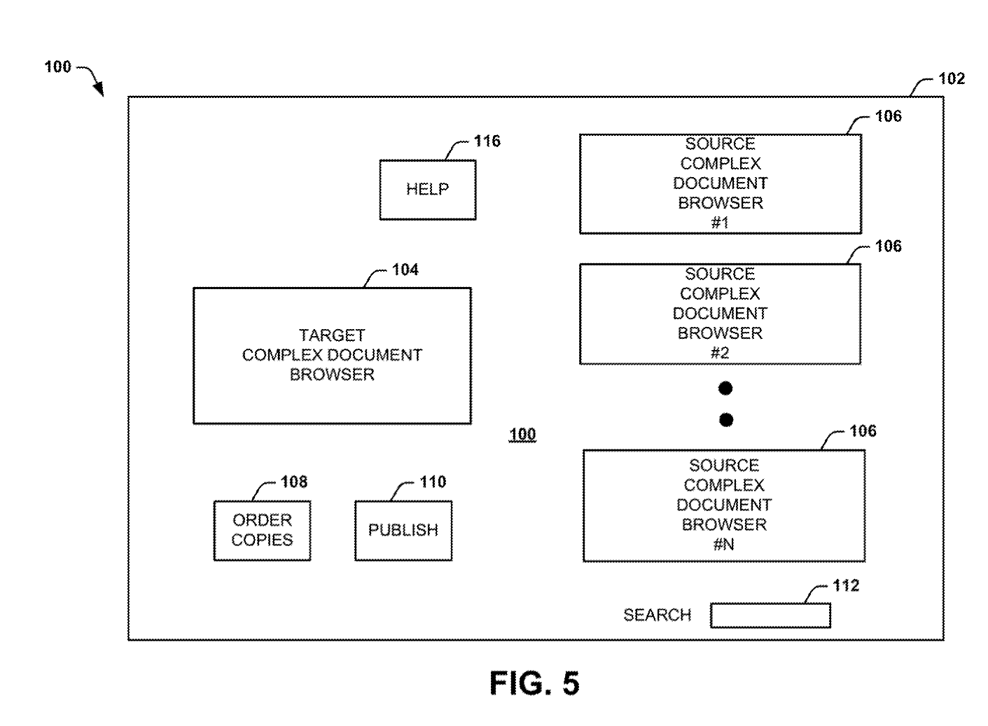

FIG. 5 illustrates a block diagram of an example graphical user interface (GUI) 100 for building and publishing complex documents. The GUI 100 includes a single user interface window 102 that includes a target complex document browser 104 and a plurality of source complex document browsers 106, labeled source complex document browser #1—source complex document browser #N. where N is an integer greater than equal to one. Displayed within the target complex document browser 104 and each of the plurality of source complex document browsers 106 is an associated complex document.

An element or container can be selected and copied (e.g., via a pointer drag and drop operation) from the plurality of source complex document browsers 106 to the target complex document browser 104 to allow a user to build a new complex document. An element or container from the plurality of source complex document browsers 106 can be selected and placed over an existing element in the target complex document browser 104, which causes the existing element to be replaced by the copied element or container. A container from the plurality of source complex document browsers 106 can be selected and placed over a container in the target complex document browser 104, which causes the target complex document container to use its own layout format to layout its existing elements along with the new container. The element or group of elements from the plurality of source complex document browsers 106 can be placed in open spaces corresponding to containers in the target complex document browser 104, which causes the existing elements to be placed into the target complex document associated with the target complex document browser 104.

The elements copied into the target complex document browser 104 can be edited. For example, text in the text element can be deleted and new text added by typing or copying into the text element. The font can be modified in the text element. Additionally, the elements in the target complex document can be copied and/or moved to other locations in the target complex document with existing elements being rearranged based on the layout engine of the container. The elements in the source complex document browsers 106 may be restricted such that the elements can be copied and not moved or edited in the source complex document browsers 106.

A container from the plurality of source complex document browsers 106 can be selected and placed over existing elements in the target complex document browser 104, which causes the container and its associated layout format to be copied to the target complex document. The element, group of elements and/or containers can be copied from the plurality of source complex document browsers 106 can be placed in open spaces in the target complex document browser 104, which causes them to be placed into the target complex document associated with the target complex document browser 104.

The GUI 102 includes an order copies function 108 that a user can select to order and receive one or more copies of the final target complex document, or any of the source complex documents, to be mailed to the user. A help function 116 is available to provide answers to questions regarding utilization of the document builder. Once the user is satisfied with the finality of the target complex document, the user can use the publish function 110 to publish the target complex document. The publishing of the target complex document adds the target complex document to the list of source complex documents and makes it available to all users of the system for re-use and purchase, or may restrict access to a restricted set of users chosen by the author. A search function represented by the search box 112 may be provided to enable the user to highlight or bring to the front relevant source complex documents by means of search terms (based on text strings, images or other search technology).

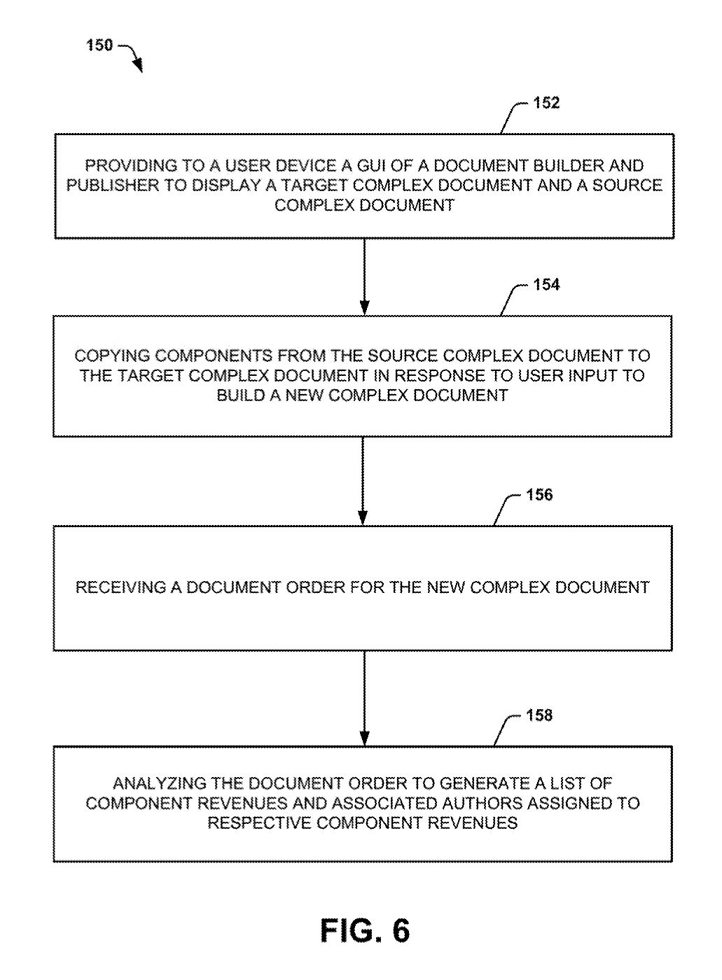

In view of the foregoing structural and functional features described above, an example methodology will be better appreciated with reference to FIG. 6. While, for purposes of simplicity of explanation, the example method of FIG. 6 is shown and described as executing serially, it is to be understood and appreciated that the present example is not limited by the illustrated order, as some actions could in other examples occur in different orders and/or concurrently from that shown and described herein.

FIG. 6 illustrates a flow chart of an example method 150 for building and publishing complex documents. The method 150 could be executed, for example, by a processor. At 152, a user device is provided a GUI of a document builder and publisher to display a target complex document and a source complex document. At 154, components are copied from the source complex document to the target complex document in response to user input to build a new complex document. At 156, a document order is received for the new complex document. At 158, the document order is analyzed to generate a list of component revenues and associated authors assigned to respective component revenues.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. Additionally, where the disclosure or claims recite “a,” an “a first,” or “another” element or the equivalent thereof, it should be interpreted to include one or more than one such element, neither requiring nor excluding two or more such elements.

What is claimed is:

1. A system (10) for building and publishing complex documents, the system (10) comprising:
a memory (12) for storing computer executable instructions; and
a processing unit (20) for accessing the memory and executing the computer executable instructions, the computer executable instructions comprising:
a document builder and publisher (26) having a graphical user interface (GUI) (100) to display a target complex document browser (16, 104) and a plurality of source complex document browsers (14, 106), such that components contained within a source complex document displayed by each of the source complex document browsers (14, 106) are copyable into a target complex document displayed by the target complex document browser (16, 104), in response to user input, to build and publish a new complex document for purchase and reuse; and
a revenue tracker (30) that analyzes document orders of complex documents to generate a list (90) of components revenues and associated authors assigned to respective component revenues and aggregate the component revenues based on the document orders to be distributed to respective associated authors.

2. The system (10) of claim 1, wherein the components are elements, fonts and layout formats of containers of complex documents and the layout formats are copied with copying of containers from the source complex document browser (14, 106) to the target complex document browser (16, 104).

3. The system (10) of claim 1, wherein the elements are not editable when in the source complex documents browsers (14, 106) and the elements are editable when in the target complex document browser (16, 104).

4. The system (10) of claim 1, the GUI (100) further allowsuser to browse through published complex documents for purchase.

5. The system (10) of claim 1, wherein the system (10) resides at a remote service accessible by a user device (36) over a network (40).

6. The system (10) of claim 1, wherein a document order is generated by printing of a target complex document, requesting delivery of copies of the target complex order or by ordering published complex documents.

7. The system (10) of claim 1, wherein the complex documents are stored as multi-level hierarchical data structures (70).

8. The system (10) of claim 1, the revenue tracker (30) to apportion revenues between co-authors of a same component.

9. A method (150) for building and publishing complex documents, the method comprising:
providing, to a user device, a graphical user interface (GUI) to a document builder and publisher to display a target complex document and a source complex document (152);
copying components from the source complex document to the target complex document in response to user input to build a new complex document (154);
receiving a document order for the new complex document (156); and
analyzing the document order to generate a list of components revenues and associated authors assigned to respective component revenues (158).

10. The method (150) of claim 9, further comprising aggregating the component revenues based on a plurality of document orders for the new complex document to be distributed to respective associated authors periodically.

11. The method (150) of claim 9, further comprising publishing the new complex document for purchase and reuse by other users of the system.

12. The method (150) of claim 11, further comprising:
generating a new document order in response to a purchase and order of a published complex document;
analyzing the new document order to generate a list of components revenues and associated authors assigned to respective component revenues; and
aggregating the component revenues by respective author with component revenues for the respective authors of other document orders for published complex document, such that the aggregated amounts are to be distributed to respective authors periodically.

13. The method (150) of claim 9, wherein the elements are not editable when in the source complex documents browsers and the elements are editable when in the target complex document browser.

14. The method (150) of claim 9, further comprising generating a document order in response to printing the new complex document by the user or ordering of copies of the new complex document by the user.

15. The method (150) of claim 9, wherein the components are elements, fonts and layout formats of containers of complex documents and the layout formats are copied with copying of containers from the source complex document to the target complex document.
